(19) United States
(12) Patent Application Publication
(10) Pub. No.: US 2018/0041080 A1
(43) Pub. Date: Feb. 8, 2018

(54) ROTOR, ROTARY ELECTRIC MACHINE, AND METHOD FOR MANUFACTURING ROTOR

(71) Applicant: Mitsubishi Electric Corporation, Chiyoda-ku, Tokyo (JP)

(72) Inventors: Aiko NAKANO, Tokyo (JP); Atsushi SAKAUE, Tokyo (JP); Masaya INOUE, Tokyo (JP); Moriyuki HAZEYAMA, Tokyo (JP); Hironori TSUIKI, Tokyo (JP); Sachiko KAWASAKI, Tokyo (JP)

(73) Assignee: Mitsubishi Electric Corporation, Chiyoda-ku, Tokyo (JP)

(21) Appl. No.: 15/556,387

(22) PCT Filed: Apr. 11, 2016
(86) PCT No.: PCT/JP2016/061666

§ 371 Date: Sep. 7, 2017

(30) Foreign Application Priority Data
May 19, 2015 (JP) 2015-101985

(51) Int. Cl. H02K 1/27; H02K 15/03; H02K 21/14; H02K 1/28

(52) U.S. Cl. CPC H02K 1/2766; H02K 1/28; H02K 15/03; H02K 21/14

(57) ABSTRACT

This rotor includes: a rotor core in which a plurality of insertion holes each penetrating the rotor core in an axial direction are formed with intervals interposed thereamong in a circumferential direction; and magnets respectively provided in the insertion holes, wherein a hole-inside-peripheral-surface of each insertion hole does not contact with a magnet-inside-peripheral-surface of a corresponding one of the magnets, a hole-outside-peripheral-surface of the insertion hole and a magnet-outside-peripheral-surface of the magnet contact with each other at two locations of a first location and a second location, an adhesive layer portion is formed between the first location and the second location and between the hole-outside-peripheral-surface of the insertion hole and the magnet-outside-peripheral-surface of the magnet, and a first protruding portion which protrudes toward outside in a radial direction and which contacts with the magnet is formed at the hole-inside-peripheral-surface of the insertion hole.

### TECHNICAL FIELD

The present invention relates to: a rotor; a rotary electric machine; and a method for manufacturing the rotor, which can reduce displacement of magnets, thereby to suppress decrease in torque, increase in stress applied to a rotor core, and increase in rotation pressure balance.

### BACKGROUND ART

In recent years, rotary electric machines used as electric motors or electric generators are required to have small sizes, high speeds, and high outputs. As a method for realizing a rotary electric machine having a small size, high speed, and high output, there is a method in which, with magnets embedded in the rotor, reluctance torque is utilized and combined with magnet torque caused by the magnets, thereby to increase generated torque. However, when a rotary electric machine having a small size and high speed is to be realized, there is a problem that stress due to centrifugal force of the rotor core becomes large, which could cause breakage of the rotor core or the magnets.

In contrast to this, as described in Patent Document 1, for example, there is a rotary electric machine in which magnets inserted in the rotor core are held by protrusions, whereby rotational centrifugal force of the magnets is reduced and stress occurring in the rotor core is reduced.

### CITATION LIST

### Patent Document

Patent Document 1: Japanese Laid-Open Patent Publication No. 2014-100048

### SUMMARY OF THE INVENTION

### Problems to be Solved by the Invention

Although such a conventional rotary electric machine has a shape in which magnets embedded in the rotor core are held by protrusions, the insertion accuracy at the time of inserting the magnets into the rotor core, and the positional accuracy of the magnets are not taken into consideration. Thus, the conventional rotary electric machine has a problem that decrease in torque, increase in stress applied to the rotor core, and increase in rotation imbalance occur.

The present invention has been made in order to solve the above-described problem. An object of the present invention is to provide a rotor, a rotary electric machine, and a method for manufacturing the rotor which reduce displacement of magnets thereby to prevent decrease in torque and increase in stress applied to the rotor core.

### Solution to the Problems

A rotor of the present invention includes:

a rotor core in which a plurality of insertion holes each penetrating the rotor core in an axial direction are formed with intervals interposed thereamong in a circumferential direction; and

magnets respectively provided in the insertion holes, wherein

a hole-inside-peripheral-surface of each insertion hole does not contact with a magnet-inside-peripheral-surface of a corresponding one of the magnets,

a hole-outside-peripheral-surface of the insertion hole and a magnet-outside-peripheral-surface of the magnet contact with each other at two locations of a first location and a second location,

an adhesive layer portion is formed between the first location and the second location and between the hole-outside-peripheral-surface of the insertion hole and the magnet-outside-peripheral-surface of the magnet, and

a first protruding portion which protrudes toward outside in a radial direction is formed at the hole-inside-peripheral-surface of the insertion hole, and the first protruding portion contacts with a circumferential-direction-side peripheral surface of the magnet.

A rotary electric machine of the present invention includes:

the rotor described above;

a rotation shaft for rotating the rotor core; and

a stator having a coil, and disposed with an air gap interposed between the stator and the rotor.

A method for manufacturing the rotor described above of the present invention includes:

a step of applying an adhesive agent to the magnet-outside-peripheral-surface of the magnet;

a step of inserting the magnet into the insertion hole;

a step of pressing the magnet-outside-peripheral-surface of the magnet and the hole-outside-peripheral-surface of the insertion hole against each other;

a step of pressing the circumferential-direction-side peripheral surface of the magnet against the first protruding portion; and

a step of forming the adhesive layer portion by causing the adhesive agent to be hardened with the rotor core being rotated.

A method for manufacturing for the rotor described above of the present invention includes:

a step of applying an adhesive agent to the magnet-outside-peripheral-surface of the magnet,

a step of inserting the magnet into the insertion hole;

a step of pressing the magnet-outside-peripheral-surface of the magnet and the hole-outside-peripheral-surface of the insertion hole against each other; and

a step of forming the adhesive layer portion, by pressing the circumferential-direction-side peripheral surface of the magnet against the first protruding portion and causing the adhesive agent to be hardened, with the rotor core being rotated.

### Effect of the Invention

According to the rotor, the rotary electric machine, and the method for manufacturing the rotor of the present invention, displacement of the magnets can be reduced, and decrease in torque, increase in stress applied to the rotor core, and increase in rotation pressure balance can be suppressed.

### BRIEF DESCRIPTION OF THE DRAWINGS

FIG. 1 is a plan view showing a configuration of a rotor of embodiment 1 of the present invention.

FIG. 2 is a partial enlarged plan view showing a configuration of the rotor shown in FIG. 1.

FIG. 3 is a perspective view showing a configuration of a rotary electric machine using the rotor shown in FIG. 1.

FIG. 4 is a plan view showing a configuration of the rotary electric machine shown in FIG. 3.

FIG. 5 is a flow chart for describing a method for manufacturing the rotor shown in FIG. 1.

FIG. 6 is a partial enlarged plan view showing a manufacturing step for the rotor shown in FIG. 1.

FIG. 7 is a partial enlarged plan view showing a manufacturing step for the rotor shown in FIG. 1.

FIG. 8 is a partial enlarged plan view for describing a state before centrifugal force is caused to act on the rotor core in a manufacturing step for the rotor shown in FIG. 1.

FIG. 9 is a partial enlarged plan view for describing a state after centrifugal force has been caused to act on the rotor core in a manufacturing step for the rotor shown in FIG. 1.

FIG. 10 is a diagram showing the difference in torque between the rotary electric machine of the present invention and a rotary electric machine of a comparative example.

FIG. 11 is a plan view showing a configuration of a rotor of embodiment 2 of the present invention.

FIG. 12 is a partial enlarged plan view showing a configuration of the rotor shown in FIG. 11.

FIG. 13 is a partial enlarged plan view for describing a state before centrifugal force is caused to act on the rotor core in a manufacturing step for the rotor shown in FIG. 11.

FIG. 14 is a partial enlarged plan view for describing a state after centrifugal force has been caused to act on the rotor core in a manufacturing step for the rotor shown in FIG. 11.

FIG. 15 is a plan view showing a configuration of a rotor of embodiment 3 of the present invention.

FIG. 16 is a partial enlarged plan view showing a configuration of the rotor shown in FIG. 15.

FIG. 17 is a partial enlarged plan view for describing a state before centrifugal force is caused to act on the rotor core in a manufacturing step for the rotor shown in FIG. 15.

FIG. 18 is a partial enlarged plan view for describing a state where centrifugal force has been caused to act on the rotor core in a manufacturing step for the rotor shown in FIG. 15.

FIG. 19 is a plan view showing a configuration of a rotor of embodiment 4 of the present invention.

FIG. 20 is a partial enlarged plan view showing a configuration of the rotor shown in FIG. 19.

FIG. 21 is a partial enlarged plan view for describing a state before centrifugal force is caused to act on the rotor core in a manufacturing step for the rotor shown in FIG. 19.

FIG. 22 is a partial enlarged plan view for describing a state after centrifugal force has been caused to act on the rotor core in a manufacturing step for the rotor shown in FIG. 19.

### DESCRIPTION OF EMBODIMENTS

### Embodiment 1

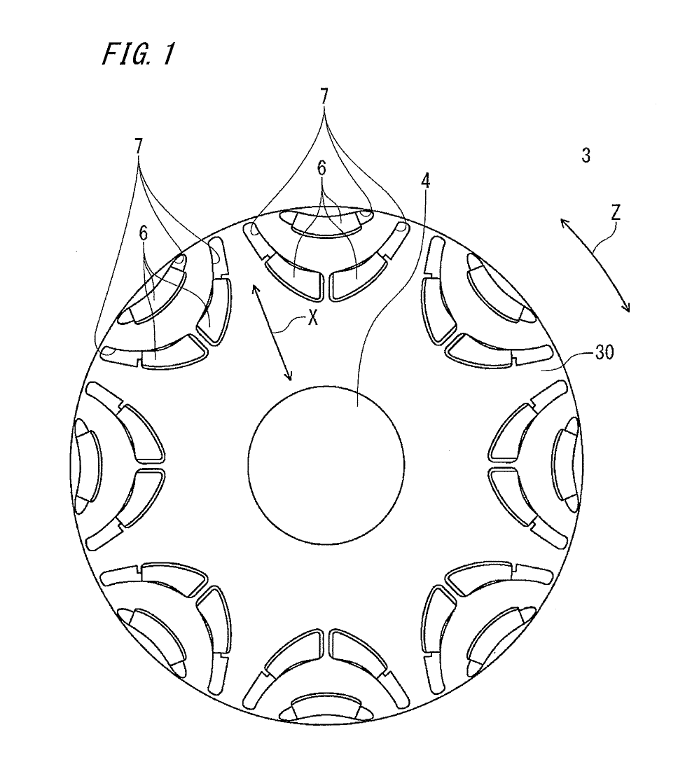

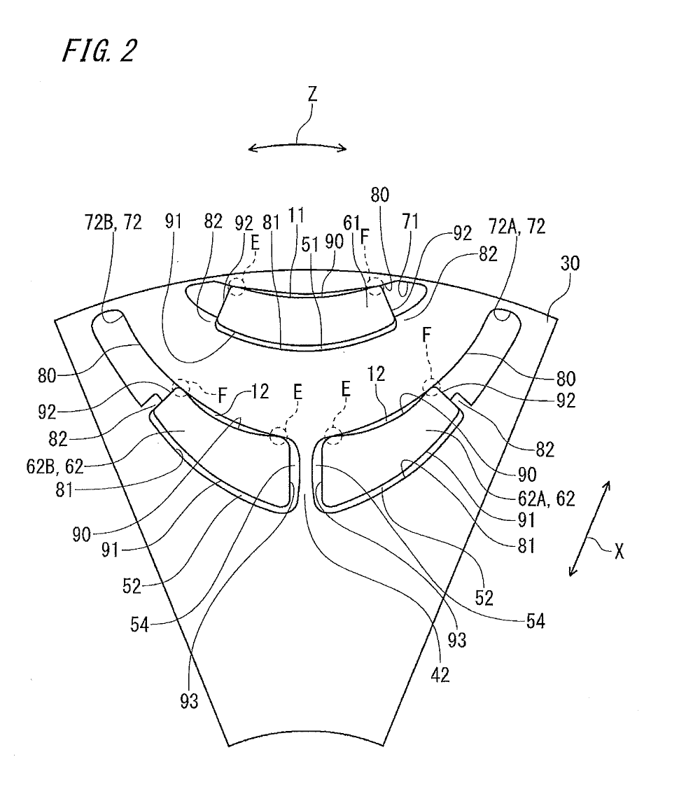

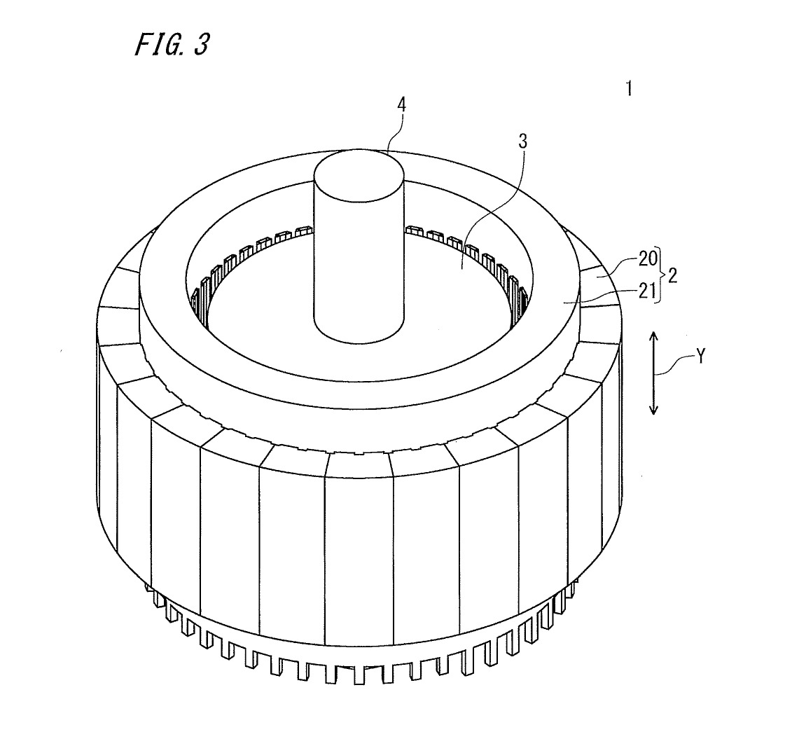

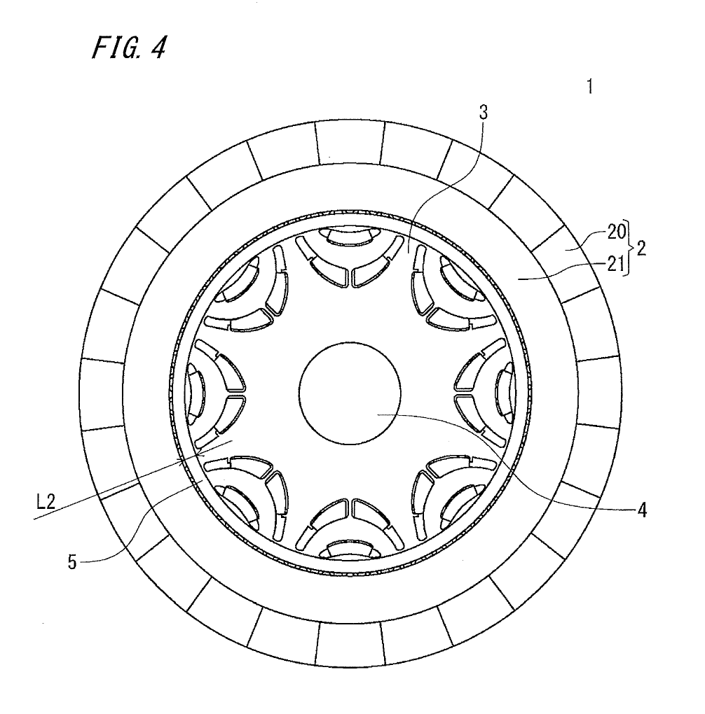

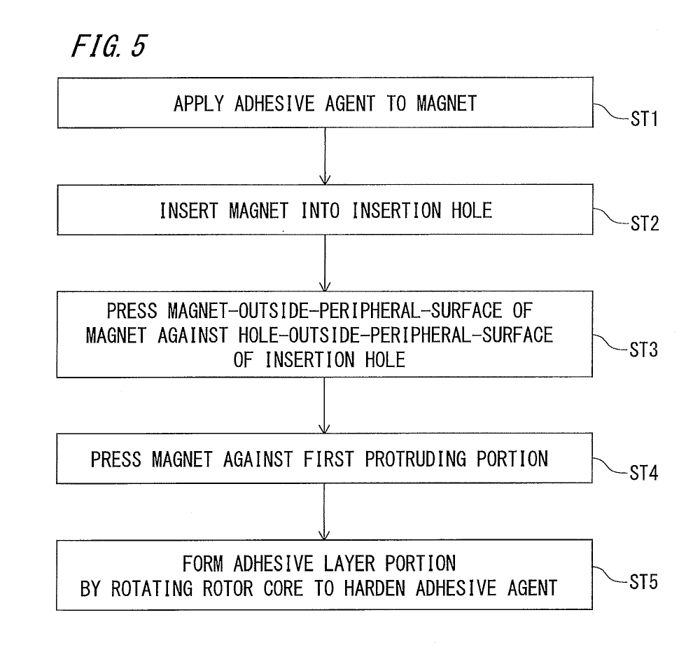

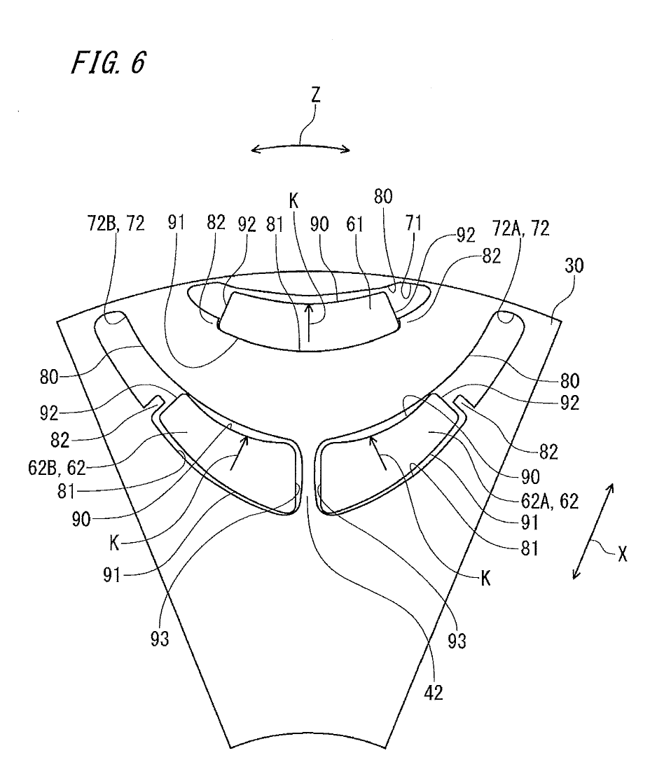

Hereinafter, embodiments of the invention of the present application will be described. FIG. 1 is a plan view showing a configuration of a rotor according to embodiment 1 of the present invention. FIG. 2 is a partial enlarged plan view showing a configuration of a ⅛ model of the rotor shown in FIG. 1. FIG. 3 is a perspective view showing a configuration of a rotary electric machine using the rotor shown in FIG. 1. FIG. 4 is a plan view showing a configuration of the rotary electric machine shown in FIG. 3. FIG. 5 is a flow chart for describing a method for manufacturing the rotor shown in FIG. 1. FIG. 6 to FIG. 9 are partial enlarged plan views showing manufacturing steps for the rotor shown in FIG. 1.

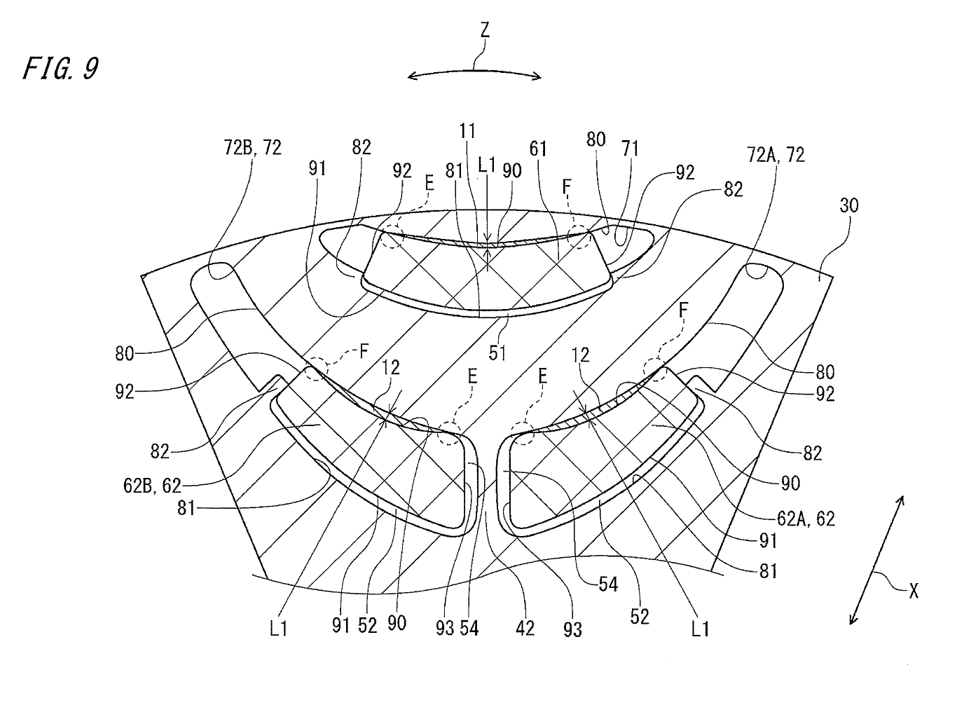

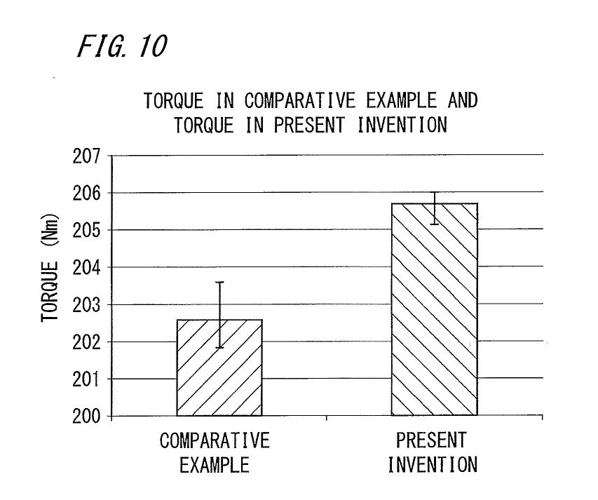

FIG. 10 is a diagram showing the difference in torque between the rotor of the present invention and a rotor of a comparative example. It is noted that hatching for facilitating understanding of the structures is provided only in FIG. 9. In other drawings, the structures are the same as those shown in FIG. 9, and hatching is omitted.

In the present embodiment, an example of a rotary electric machine 1 of a permanent magnet type having 8 poles and 48 slots is described. However, the number of poles and the number of slots of the rotary electric machine 1 can be increased or decreased as appropriate, and such configurations are applicable not only to the present embodiment but also to embodiments thereafter. Thus, the description thereof is omitted as appropriate.

In FIG. 3 and FIG. 4, the rotary electric machine 1 is composed of a stator 2, a rotor 3, and a shaft 4. From the outer peripheral side of the rotary electric machine 1, the stator 2, the rotor 3, and the shaft 4 are arranged in this order. The stator 2 is disposed with an air gap 5, which is a gap, interposed between the stator 2 and the rotor 3. The air gap 5 is formed such that an interval L2 in the radial direction is 0.1 mm to 2.5 mm.

The stator 2 has a stator core 20 and a coil 21. The stator core 20 is formed in an annular shape. The stator core 20 is formed, for example, by stacking a plurality of electromagnetic steel sheets in an axial direction Y. The thickness of one electromagnetic steel sheet is 0.1 mm to 1.0 mm in many cases. In the present embodiment, an example has been shown in which the stator core 20 is composed of electromagnetic steel sheets, but without being limited thereto, the stator core 20 may be composed of materials other than the electromagnetic steel sheet. Such configurations are also applicable to the embodiments below, and thus, the description thereof is omitted as appropriate. The coil 21 wound on the stator core 20 may be either of a distributed-winding type or a concentrated-winding type.

The rotor 3 is formed, with a rotor core 30 being fixed to the shaft 4 which is inserted at the axial position thereof. The rotor 3 is a permanent magnet type rotor in which the rotor core 30 is disposed inside the stator 2 and which is provided with permanent magnets 6. The shaft 4 is fixed to the rotor core 30 through, for example, shrink fitting, press-fitting, or the like.

Next, details of the configuration of the rotor 3 are described with reference to FIG. 1 and FIG. 2. As shown in FIG. 1, the rotor 3 is composed of : the rotor core 30 in which a plurality of insertion holes 7 each penetrating the rotor core 30 in the axial direction Y are formed with intervals thereamong in a circumferential direction Z; permanent magnets 6 (hereinafter, the permanent magnet is referred to as “magnet”) respectively provided in the insertion holes 7; and the shaft 4 for rotating the rotor core 30.

Thus, each magnet 6 is formed in a shape and a size that allow the magnet 6 to be inserted in a corresponding insertion hole 7. It is noted that, in the description below, the expression “magnet 6” is intended to refer to all the magnets 6 in the rotor 3, and the expression “insertion hole 7” is intended to refer to all the insertion holes 7 in the rotor 3.

As shown in FIG. 2, a plurality of the insertion holes 7 are formed with intervals interposed thereamong in the circumferential direction Z of the rotor core 30, and are formed in a plurality of layers in a radial direction X. In the present embodiment, a case in which the insertion holes 7 are arranged in two layers in the radial direction X is described. The insertion hole 7 has two layers of a first insertion hole 71 and a second insertion hole 72. In the second insertion hole 72, a second bridge portion 42 is formed on the magnetic pole central axis, and a second insertion hole 72A and a second insertion hole 72B are formed by being divided in left-right line symmetry with respect to the central axis.

A first magnet 61 is inserted in the first insertion hole 71, a second magnet 62A is inserted in the second insertion hole 72A, and a second magnet 62B is inserted in the second insertion hole 72B. Thus, each second magnet 62 is composed of the second magnet 62A and the second magnet 62B.

A hole-outside-peripheral-surface 80 and a hole-inside-peripheral-surface 81 are each formed in an arc surface shape that inwardly protrudes in the radial direction X of the rotor 3, the hole-outside-peripheral-surface 80 being the lateral surface extending in the circumferential direction Z and at the outside in the radial direction X of each insertion hole 71, 72, the hole-inside-peripheral-surface 81 being the lateral surface extending in the circumferential direction Z and at the inside in the radial direction X of each insertion hole 71, 72. In addition, a magnet-outside-peripheral-surface 90 and a magnet-inside-peripheral-surface 91 are each formed in an arc surface shape that inwardly protrudes in the radial direction X of the rotor 3, the magnet-outside-peripheral-surface 90 being the surface extending in the circumferential direction Z and at the outside in the radial direction X of each magnet 61, 62, the magnet-inside-peripheral-surface 91 being the surface extending in the circumferential direction Z and at the inside in the radial direction X of each magnet 61, 62.

When the radius of curvature for forming the hole-outside-peripheral-surface 80 of each insertion hole 71, 72 into an arc surface shape is defined as R1, and the radius of curvature for forming the magnet-outside-peripheral-surface 90 of each magnet 61, 62 into an arc surface shape is defined as R2, a relationship of R1>R2 is satisfied. It is noted that the radius of curvature R1 and the radius of curvature R2 merely indicate the relationship therebetween, and the numerical values thereof are set as appropriate, respectively.

Since the insertion hole 7 and the magnet 6 are formed in this relationship, the hole-outside-peripheral-surface 80 of each insertion hole 71, 72 and the magnet-outside-peripheral-surface 90 of each magnet 61, 62 contact with each other at two locations of a first location E and a second location F. In addition, the hole-inside-peripheral-surface 81 of the first insertion hole 71 and the magnet-inside-peripheral-surface 91 of the first magnet 61 do not contact with each other and are provided with a gap therebetween, whereby a first gap portion 51 is formed. In addition, the hole-inside-peripheral-surface 81 of the second insertion hole 72 and the magnet-inside-peripheral-surface 91 of the second magnet 62 do not contact with each other and are provided with a gap therebetween, whereby a second gap portion 52 is formed.

As shown in FIG. 9, a first adhesive layer portion 11 is formed between the first location E and the second location F and between the hole-outside-peripheral-surface 80 of the first insertion hole 71 and the magnet-outside-peripheral-surface 90 of the first magnet 61. In addition, a second adhesive layer portion 12 is formed between the hole-outside-peripheral-surface 80 of the second insertion hole 72 and the magnet-outside-peripheral-surface 90 of the second magnet 62. A maximum interval L1 in the radial direction X of each adhesive layer portion 11, 12 is about 5/100 (mm)<L1<20/100 (mm).

Each adhesive layer portion 11, 12 and the maximum interval L1 are shown in FIG. 9, but indication thereof is omitted in other drawings as appropriate. Also in the embodiments below, indication of the adhesive layer portion 11, 12 and the maximum interval L1 is omitted as appropriate.

When the maximum interval L1 is smaller than 5/100 mm, the adhesive force of each adhesive layer portion 11, 12 is reduced, thereby causing unevenness on the surface of the adhesive agent.

When the maximum interval L1 is greater than 20/100 mm, each magnet 61, 62 might slip off because the adhesive agent does not stay in the gap due to the surface tension of the adhesive agent during rotation. Therefore, the radius of curvature R1 and the radius of curvature R2 mentioned above are set such that the maximum interval L1 satisfies the relationship described above. The maximum interval L1 of each adhesive layer portion 11, 12 is set in accordance with the location corresponding thereto, within the range described above.

The above-described relationship between the radius of curvature R1 and the radius of curvature R2, and the above-described relationship of the maximum interval L1 can be similarly realized at the insertion hole 7 and the magnet 6 in the each layer formed in the radial direction X, and thus, can also be realized similarly in the embodiments below. Therefore, description thereof is omitted as appropriate.

At the hole-inside-peripheral-surface 81 of the first insertion hole 71, a first protruding portion 82 is formed which protrudes toward the outside in the radial direction X and which contacts with a circumferential-direction-side peripheral surface 92 in the circumferential direction Z of the first magnet 61. The first magnet 61 inserted in the first insertion hole 71 moves in either of the directions in the circumferential direction Z, due to centrifugal force caused by rotation of the rotor core 30. Therefore, the first protruding portion 82 is formed at two locations in the circumferential direction Z, so as to allow either of the two circumferential-direction-side peripheral surfaces 92 in the circumferential direction Z of the first magnet 61 to contact with the first protruding portion 82 in the circumferential direction Z within the first insertion hole 71. The circumferential-direction-side peripheral surface 92 of the magnet 6 and the first protruding portion 82 that do not contact with each other has an interval therebetween, whereby the magnet 6 need not be pressed into the insertion hole 7 when the magnet 6 is to be inserted thereinto. This configuration also applies to the embodiments below.

At the hole-inside-peripheral-surface 81 of the second insertion hole 72A, 72B, a first protruding portion 82 is formed which protrudes toward the outside in the radial direction X and which contacts with the circumferential-direction-side peripheral surface 92 that is on the opposite side to the side where the second bridge portion 42 in the circumferential direction Z of the second magnet 62A, 62B is formed. The second magnet 62 inserted in the second insertion hole 72 moves to the outside in the radial direction X, due to centrifugal force caused by rotation of the rotor core 30. Therefore, the first protruding portion 82 is formed on the opposite side to the second bridge portion 42. Furthermore, the second magnet 62A, 62B does not contact with the second bridge portion 42. A gap is provided between the second bridge portion 42 and another circumferential-direction-side peripheral surface 93, which is the outer peripheral side of the circumferential-direction-side peripheral surface of the second magnet 62A, 62B, whereby a fourth gap portion 54 is formed.

Next, a method for manufacturing the rotor for a rotary electric machine configured as described above according to embodiment 1 is described with reference to FIG. 5 to FIG. 7. First, an adhesive agent is applied to the magnet-outside-peripheral-surface 90 of the magnet 6 (step ST1 in FIG. 5). It is noted that, as the material of the adhesive agent, any material may be used as long as the material can fix the magnet 6 and the insertion hole 7 together. The adhesive agent that has been applied but has not been hardened is not shown. This also applies to the embodiments below. Next, as shown in FIG. 6, the magnet 6 is inserted into the insertion hole 7 (step ST2 in FIG. 5). At the insertion of the magnet 6, the magnet 6 is inserted in the insertion hole 7 at a position that is as close as possible to the magnetic pole central axis of the rotor 3.

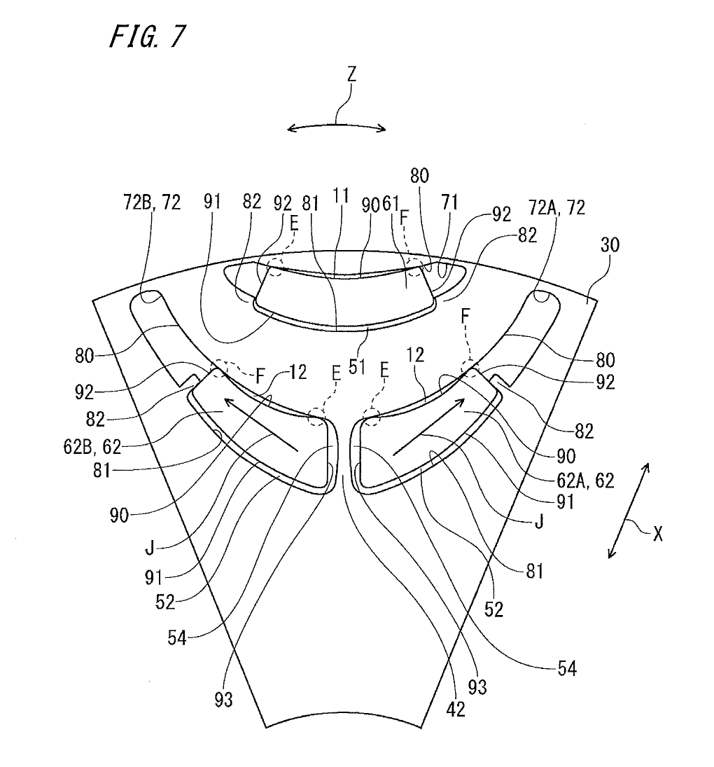

Next, each magnet 6 is moved in the direction of an arrow K from the state shown in FIG. 6, and then, as shown in FIG. 7, the magnet-outside-peripheral-surface 90 of the magnet 6 is pressed against the hole-outside-peripheral-surface 80 of the insertion hole 7 (step ST3 in FIG. 5). For this pressing step, any condition may be employed as long as the condition does not cause cracking or chipping of the magnet 6 or the insertion hole 7, wherein any means and any number of times of pressing the magnet 6 against the insertion hole 7 may be employed.

At this time, the magnet-inside-peripheral-surface 91 of the magnet 6 and the hole-inside-peripheral-surface 81 of the insertion hole 7 do not contact with each other, and a gap is provided between the magnet-inside-peripheral-surface 91 of the magnet 6 and the hole-inside-peripheral-surface 81 of the insertion hole 7. Accordingly, the first gap portion 51 and the second gap portion 52 are each formed.

Next, the magnet 6 is moved in the direction of an arrow J shown in FIG. 7, that is, toward the first protruding portion 82. It is noted that the first magnet 61 may be moved in either of the directions in the circumferential direction Z. Then, the circumferential-direction-side peripheral surface 92 of the magnet 6 is caused to contact with the first protruding portion 82 (step ST4 in FIG. 5). At this time, the second magnet 62A, 62B and the second bridge portion 42 do not contact with each other, and a gap is provided between the another circumferential-direction-side peripheral surface 93 of the second magnet 62A, 62B and the second bridge portion 42, whereby the fourth gap portion 54 is formed. Next, the rotor core 30 is rotated, and the adhesive agent is hardened to form each adhesive layer portion 11, 12 (step ST5 in FIG. 5).

The rotor 3 is manufactured as described above, but before centrifugal force is caused to act by rotating the rotor core 30 and before the adhesive agent is hardened, the position of the magnet 6 could become unstable in the circumferential direction Z. Therefore, by rotating the rotor core 30 to cause centrifugal force to act, it is possible to make the position of the magnet 6 stable in the insertion hole 7 as shown in FIG. 9. In the following, this state is described.

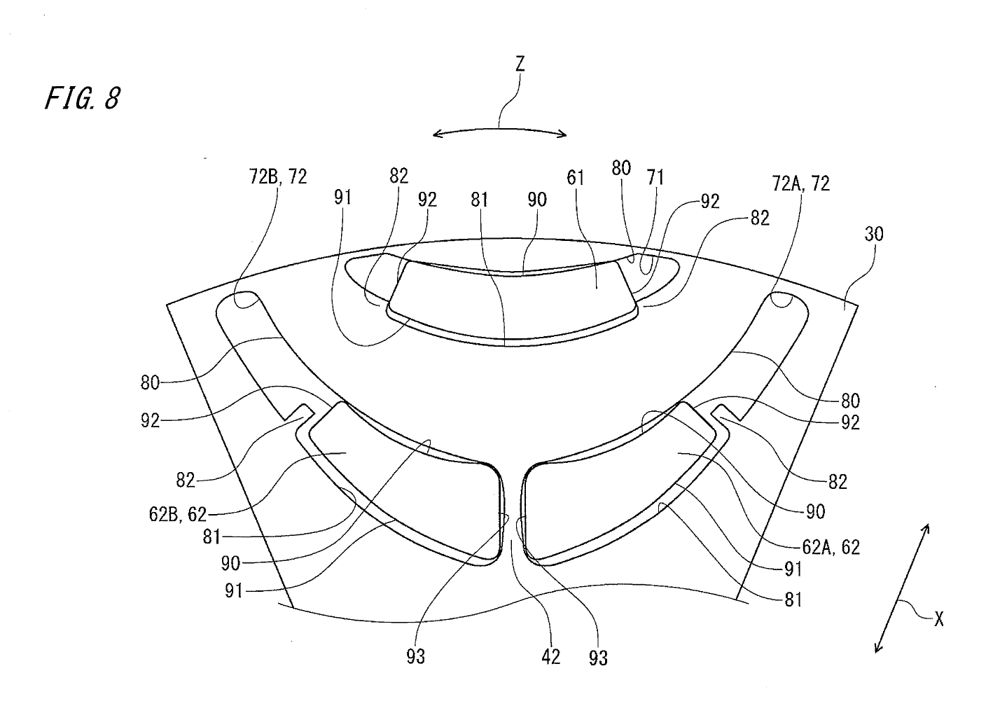

First, before the centrifugal force acts, the magnet 6 and the insertion hole 7 are not completely fixed together by the adhesive agent, as shown in FIG. 8. Thus, after the first magnet 61 is inserted in the first insertion hole 71, the first magnet 61 is pressed toward the outside in the radial direction X until the magnet-outside-peripheral-surface 90 contacts with the hole-outside-peripheral-surface 80, whereby the magnet-outside-peripheral-surface 90 and the hole-outside-peripheral-surface 80 contact with each other at two points. However, since the first magnet 61 is not yet fixed in the circumferential direction Z of the rotor 3, variation in the insertion manner of the first magnet 61 causes the first magnet 61 to contact with either of the left and right first protruding portions 82, or to contact with neither of the left and right first protruding portions 82. Thus, the position in the circumferential direction Z of the first magnet 61 is unstable.

Also with respect to the second magnet 62, similarly to the first magnet 61, after the second magnet 62 is inserted in the second insertion hole 72, the second magnet 62 is pressed toward the outside in the radial direction X until the magnet-outside-peripheral-surface 90 contacts with the hole-outside-peripheral-surface 80, whereby the magnet-outside-peripheral-surface 90 and the hole-outside-peripheral-surface 80 contact with each other at two points. Further, the circumferential-direction-side peripheral surface 92 of the second magnet 62 is caused to contact with the first protruding portion 82. However, before the adhesive agent is hardened, the second magnet 62 is not yet fixed in the circumferential direction Z of the rotor 3, and thus, the second magnet 62 could move to the magnetic pole central axis, that is, to the side where the second bridge portion 42 is formed. Thus, the position in the circumferential direction Z of the second magnet 62 is unstable.

In this state, the rotor core 30 is rotated to apply centrifugal force to the outside in the radial direction X of the rotor core 30, and the adhesive agent is hardened to form each adhesive layer portion 11, 12 (FIG. 9). That is, when the rotor 3 is rotated, centrifugal force toward the outside in the radial direction X of the rotor 3 is applied to the magnet 6 and the insertion hole 7. Due to this centrifugal force, the first magnet 61 moves to the outside in the radial direction X of the rotor 3, and the contacts at the two points between the magnet-outside-peripheral-surface 90 of the first magnet 61 and the hole-outside-peripheral-surface 80 of the first insertion hole 71 are fixed at the first location E and the second location F. In addition, either of the left and right circumferential-direction-side peripheral surfaces 92 in the circumferential direction Z of the first magnet 61 contacts with a corresponding one of the left and right first protruding portions 82. As a result, the first magnet 61 contacts with the first insertion hole 71 at three locations therein, thereby being stabilized at a specific position.

Similarly to the first magnet 61, also to the second magnet 62A, 62B, centrifugal force toward the outside in the radial direction X of the rotor 3 is applied. Due to this centrifugal force, the second magnet 62A, 62B moves to the outside in the radial direction X of the rotor 3, and the contacts at the two points between the magnet-outside-peripheral-surface 90 of the second magnet 62A, 62B and the hole-outside-peripheral-surface 80 of the second insertion hole 72A, 72B are fixed at the first location E and the second location F. In addition, the circumferential-direction-side peripheral surface 92 of the second magnet 62A, 62B contacts with the first protruding portion 82. As a result, the second magnet 62 contacts with the second insertion hole 72 at three locations therein, thereby being stabilized at a specific position.

The above-described relationship between the magnet 6 and the insertion hole 7 in the fixation thereof before centrifugal force is caused to act on the rotor core 30 and after centrifugal force is caused to act on the rotor core 30 is the same also in the embodiments below, and thus, description thereof is omitted as appropriate.

Next, a method for assembling the rotary electric machine 1 by use of the rotor 3 manufactured as described above is described. With respect to the stator 2, the stator core 20 is formed by stamping an electromagnetic steel sheet which is a main material. The method for forming the stator core 20 is not limited to stamping an electromagnetic steel sheet. Next, an insulating sheet is attached to the coil 21 assembled in an annular shape, and the resultant coil 21 is inserted in the stator core 20. It is noted that the method for assembling the coil 21 and the stator core 20 is not limited to this method. Next, the shaft 4 is fixed to the rotor core 30 of the rotor 3 manufactured as described above. Next, the rotor 3 is inserted in the stator 2 with the air gap 5 therebetween, to assemble the rotor 3 and the stator 2 together, whereby the rotary electric machine 1 is manufactured. It is noted that the configuration of the rotary electric machine 1 can be realized similarly in the embodiments below, and thus, is not described and not shown in the drawings.

According to embodiment 1 configured as described above, since a gap is provided so as to prevent eventual contact between the hole-inside-peripheral-surface of the insertion hole and the magnet-inside-peripheral-surface of the magnet, the magnet can be easily inserted in the insertion hole. Then, eventually, the magnet-outside-peripheral-surface of the magnet and the hole-outside-peripheral-surface of the insertion hole are caused to contact with each other at two locations, and the magnet and the first protruding portion are caused to contact with each other, whereby the magnet and the insertion hole contact with each other at three locations. Accordingly, the positional accuracy of the magnet in the insertion hole can be enhanced. Thus, decrease in torque, increase in stress applied to the rotor core, and increase in rotation imbalance due to variation in the position of the magnet can be reduced.

Specifically, FIG. 10 shows the difference between torque in a comparative example employing a rotary electric machine where magnets are inserted and fixed in insertion holes through pressure welding, and torque in the present invention. Both torques were calculated under the same condition. Apparent from FIG. 10, the torque in the present invention is greater. From this, it has been confirmed that the present invention can prevent variation of decrease in the torque of the magnets.

In addition, the magnet-outside-peripheral-surface of the magnet and the hole-outside-peripheral-surface of the insertion hole are each formed in an arc surface shape that inwardly protrudes in the radial direction. This reliably causes the magnet-outside-peripheral-surface of the magnet and the hole-outside-peripheral-surface of the insertion hole to contact with each other at two locations. Accordingly, the positional accuracy of the magnet in the insertion hole can be further enhanced.

In addition, since the bridge portion in the left-right line symmetry is formed on the magnetic pole central axis in the insertion hole, concentration of stress applied to the rotor core can be reduced.

In addition, with the rotor core being rotated, the adhesive agent is hardened to form the adhesive layer portion, and thus, the positional accuracy of the magnet in the insertion hole can be further enhanced.

In the present embodiment, an example has been described in which: the magnet is pressed against the first protruding portion; and then, with the rotor core being rotated, the adhesive agent is hardened to form the adhesive layer portion. However, the present invention is not limited thereto. For example, a configuration may be employed in which: with the rotor core being rotated, the magnet is pressed against the first protruding portion and the adhesive agent is hardened to form the adhesive layer portion. In this case, since the magnet is pressed against the first protruding portion with the rotor core being rotated, the number of steps can be reduced, and thus, low cost manufacture can be realized.

In the present embodiment, an example has been described in which: the hole-outside-peripheral-surface 80 of each insertion hole 71, 72 and the magnet-outside-peripheral-surface 90 of each magnet 61, 62 are each formed in an arc surface shape that inwardly protrudes in the radial direction X of the rotor 3; and the hole-outside-peripheral-surface 80 and the magnet-outside-peripheral-surface 90 are caused to contact with each other at the two locations of the first location E and the second location F. However, the present invention is not limited thereto. Even when another shape is employed, if the hole-outside-peripheral-surface 80 of the insertion hole 7 and the magnet-outside-peripheral-surface 90 of the magnet 6 are caused to contact with each other at the two locations of the first location E and the second location F, and if each adhesive layer portion 11, 12 can be formed between the first location E and the second location F and between the hole-outside-peripheral-surface 80 of the insertion hole 7 and the magnet-outside-peripheral-surface 90 of the magnet 6, similar configurations to those of the present embodiment can be realized, and the same effects as those in the present embodiment can be realized. This also applies to the embodiments below, and thus, description thereof is omitted as appropriate.

### Embodiment 2

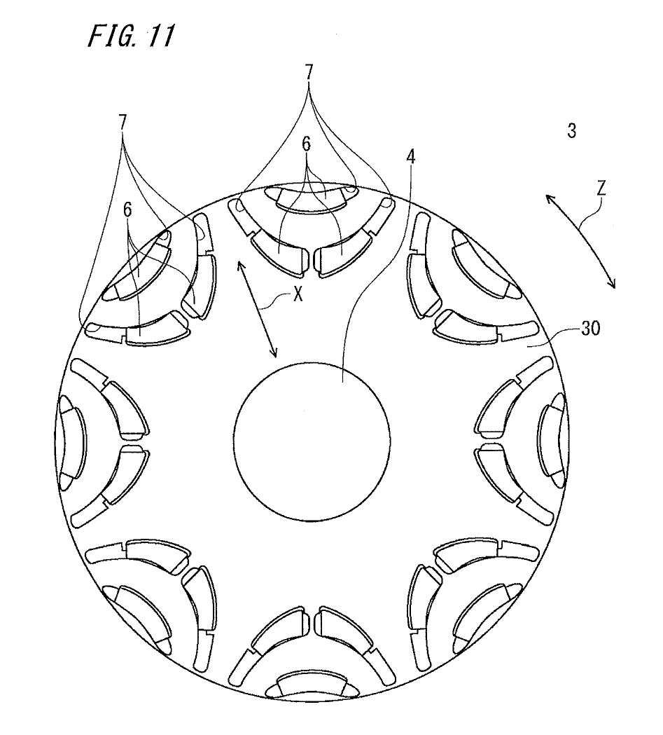

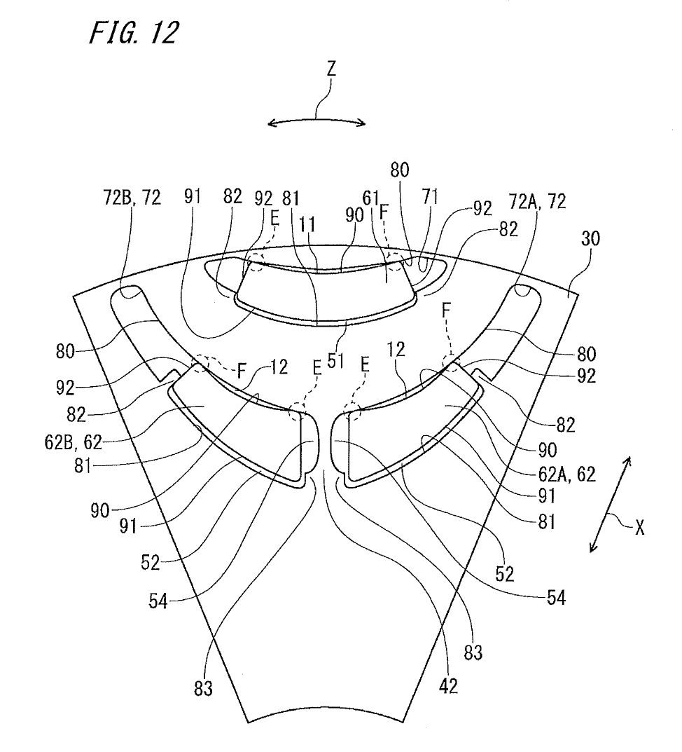

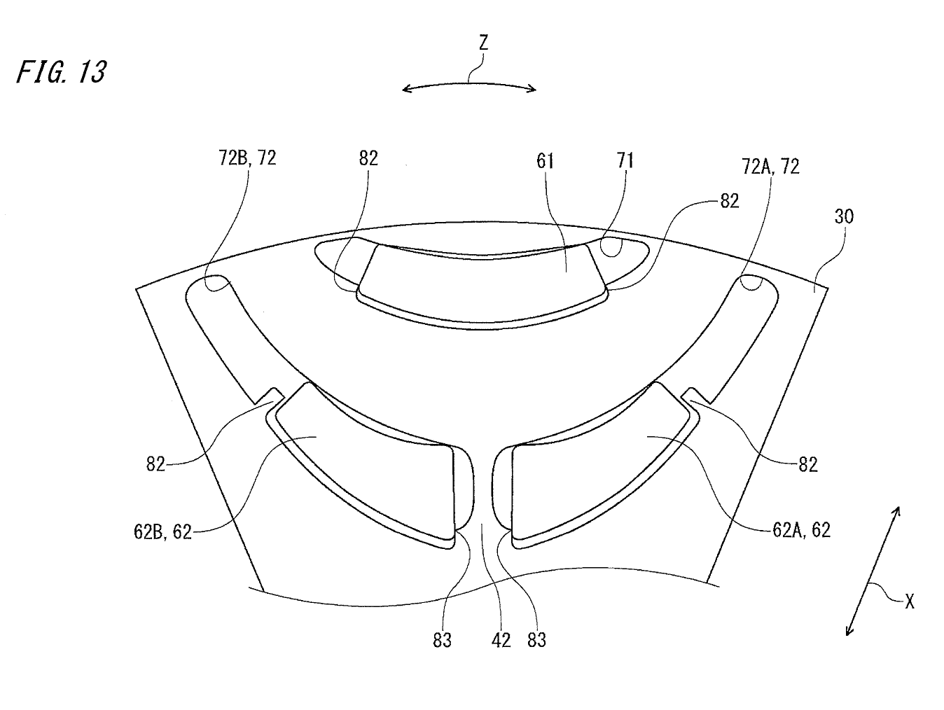

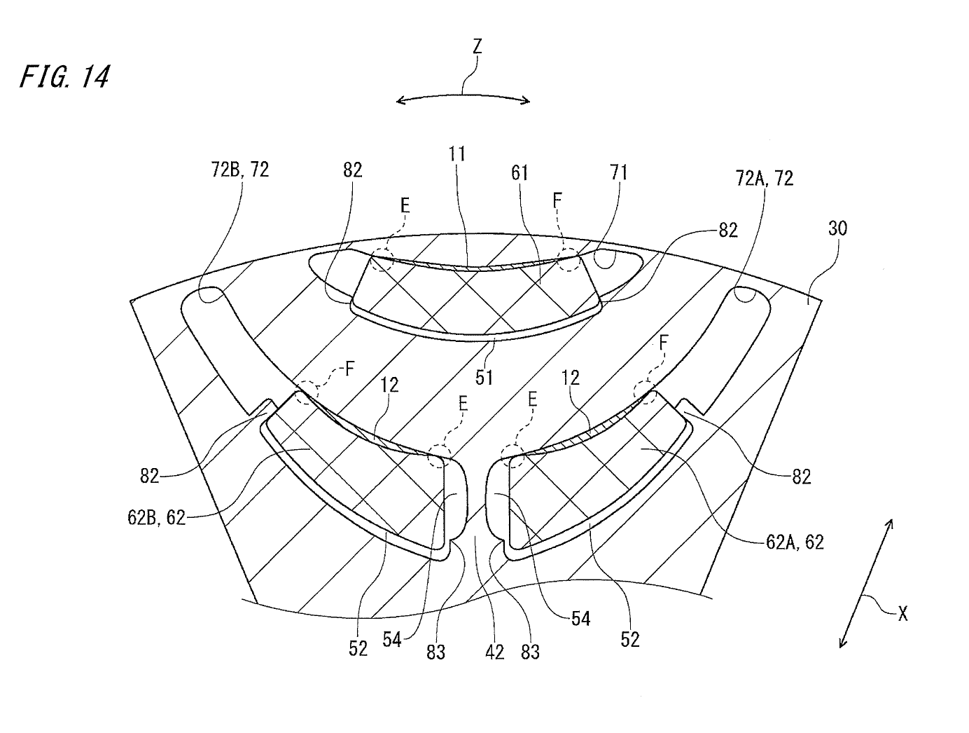

FIG. 11 is a plan view showing a configuration of a rotor of embodiment 2 of the present invention. FIG. 12 is a partial enlarged plan view showing a configuration of a ⅛ model of the rotor shown in FIG. 11. FIG. 13 is a partial enlarged plan view for describing a state before centrifugal force is caused to act on the rotor core in a manufacturing step for the rotor shown in FIG. 11. FIG. 14 is a partial enlarged plan view for describing a state after centrifugal force has been caused to act on the rotor core in a manufacturing step for the rotor shown in FIG. 11. It is noted that hatching for facilitating understanding of the structures is provided only in FIG. 14. In other drawings, the structures are the same as those shown in FIG. 14, and hatching is omitted.

In the drawings, parts similar to those in embodiment 1 above are denoted by the same reference characters and description thereof is omitted. At the second bridge portion 42 in the second insertion hole 72, second protruding portions 83 are formed which respectively protrude to the second magnet 62 sides in the second insertion hole 72, and which do not contact with the second magnets 62, respectively.

The rotor for the rotary electric machine of embodiment 2 configured as described above can be manufactured as shown in FIG. 5 as in embodiment 1 above. However, before centrifugal force is caused to act by rotating the rotor core 30 and before the adhesive agent is hardened, the position of the magnet 6 could become unstable in the circumferential direction Z. Thus, by rotating the rotor core 30 to cause centrifugal force to act, it is possible to make the position of the magnet 6 stable in the insertion hole 7 as shown in FIG. 14. In the following, this state is described.

First, before centrifugal force acts, the magnet 6 and the insertion hole 7 are not completely fixed together by the adhesive agent as shown in FIG. 13. The relationship between the first magnet 61 and the first insertion hole 71 is the same as in embodiment 1 above, and description thereof is omitted. After the second magnet 62 is inserted in the second insertion hole 72, the second magnet 62 is pressed toward the outside in the radial direction X until the magnet-outside-peripheral-surface 90 contacts with the hole-outside-peripheral-surface 80, whereby the magnet-outside-peripheral-surface 90 and the hole-outside-peripheral-surface 80 contact with each other at two points. Further, the circumferential-direction-side peripheral surface 92 of the second magnet 62 is caused to contact with the first protruding portion 82. However, before the adhesive agent is hardened, the second magnet 62 is not yet fixed in the circumferential direction Z of the rotor 3, and thus, the second magnet 62 could move to the magnetic pole central axis, that is, to the side where the second bridge portion 42 is formed. As a result, the another circumferential-direction-side peripheral surface 93 of the second magnet 62 contacts with the second protruding portion 83 formed at the second bridge portion 42. This hinders the second magnet 62 from being disposed at a specific position in the circumferential direction Z.

In this state, the rotor core 30 is rotated to apply centrifugal force to the outside in the radial direction X of the rotor core 30. Then, the adhesive agent is hardened to form each adhesive layer portion 11, 12 (FIG. 14). That is, when the rotor 3 is rotated, centrifugal force toward the outside in the radial direction X of the rotor 3 is applied to the magnet 6, i.e., to the second magnet 62A, 62B.

Then, the second magnet 62A, 62B moves to the outside in the radial direction X of the rotor 3, and the contacts at the two points between the magnet-outside-peripheral-surface 90 of the second magnet 62A, 62B and the hole-outside-peripheral-surface 80 of the second insertion hole 72A, 82B are fixed at the first location E and the second location F. In addition, the circumferential-direction-side peripheral surface 92 of the second magnet 62A, 62B contacts with the first protruding portion 82. As a result, the second magnet 62 contacts with the second insertion hole 72 at three locations therein, thereby being stabilized at a specific position.

According to embodiment 2 configured as described above, it is needless to say that the same effects as those in embodiment 1 above can be exhibited. If the insertion hole having the bridge portion formed therein is not provided with the second protruding portions, the magnets and the bridge portion might contact with each other, and in such a case, the distance of flux barrier that hinders magnetic flux from passing therethrough is shortened. Thus, magnetic flux leakage of the magnets could occur.

In the present embodiment 2, since the insertion hole having the bridge portion formed therein is provided with the second protruding portions, the magnets and the second protruding portions contact with each other, and the magnets and the bridge portion do not contact with each other, whereby the flux barrier can be secured between the magnets and the bridge portion. Thus, magnetic flux leakage of the magnets can be suppressed, and decrease in torque can be prevented.

### Embodiment 3

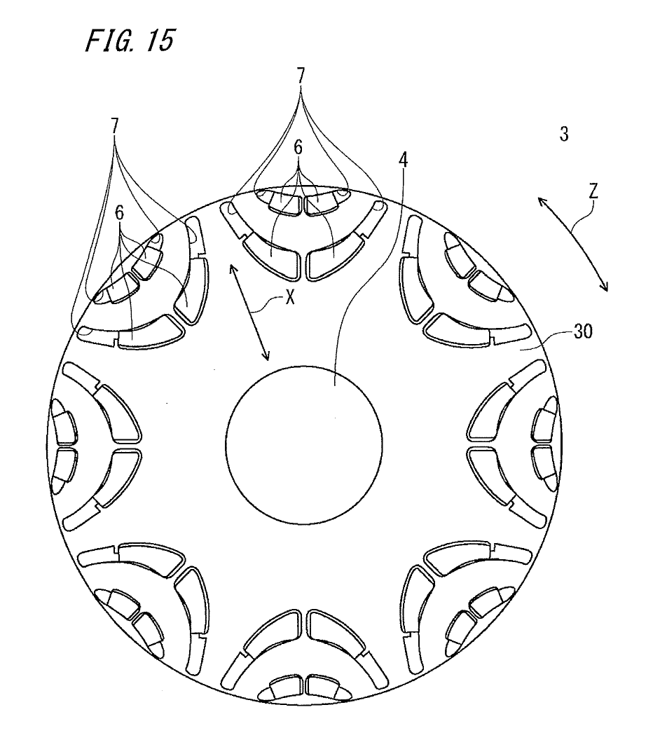

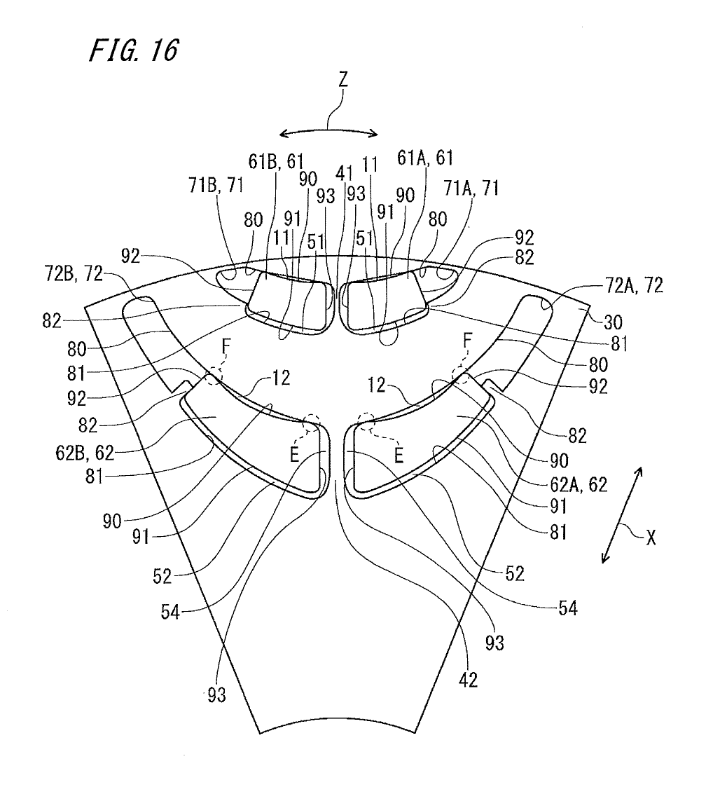

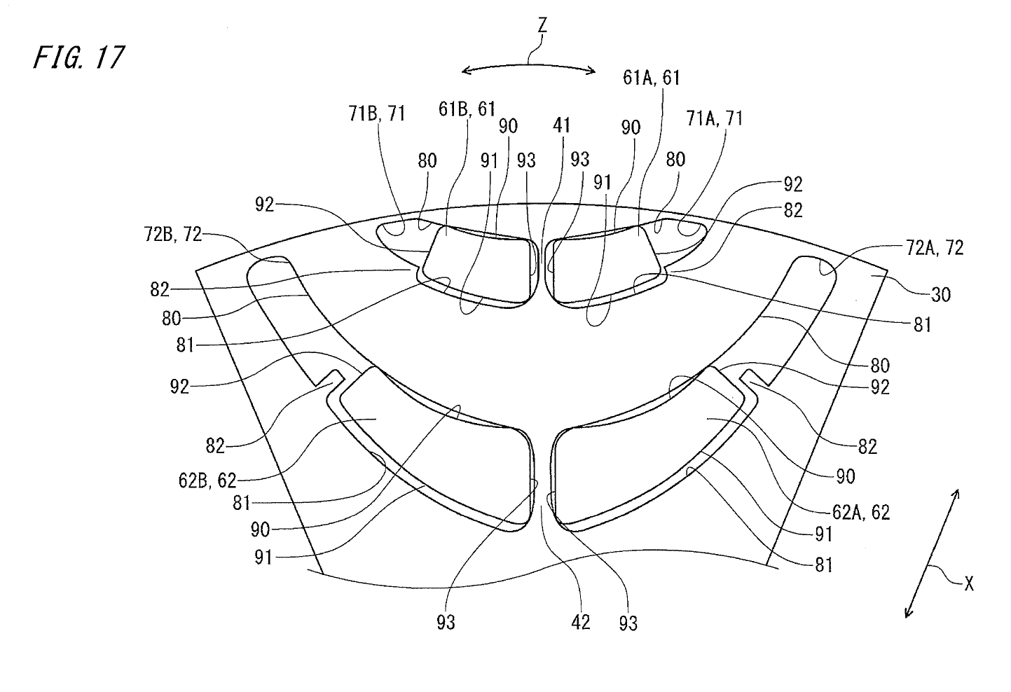

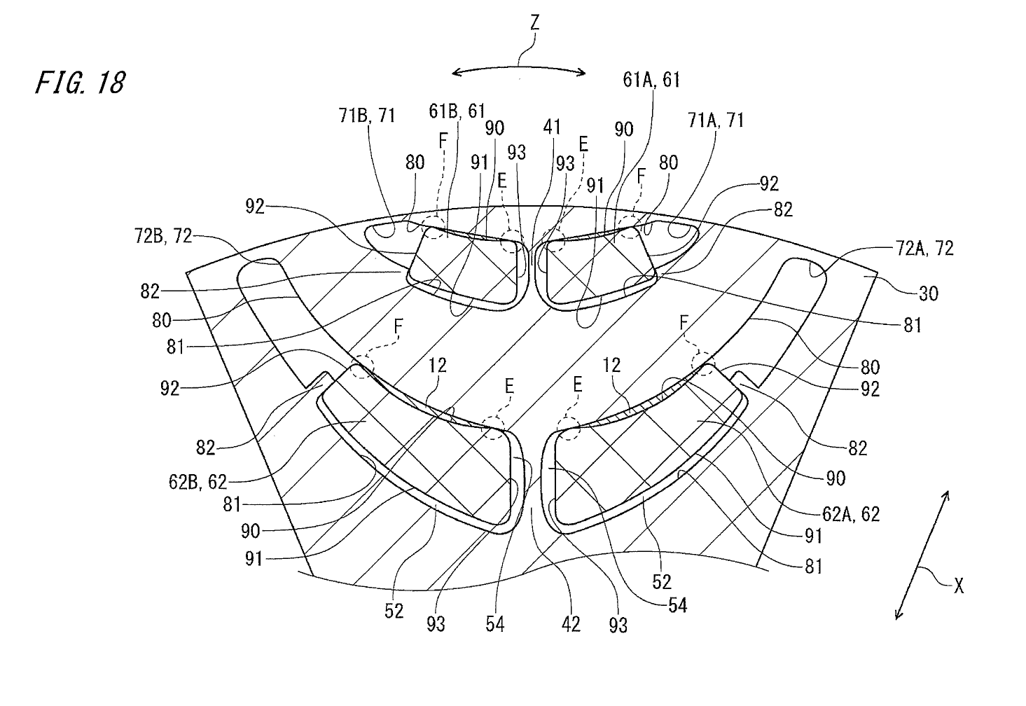

FIG. 15 is a plan view showing a configuration of a rotor of embodiment 3 of the present invention. FIG. 16 is a partial enlarged plan view showing a configuration of a ⅛ model of the rotor shown in FIG. 15. FIG. 17 is a partial enlarged plan view for describing a state before centrifugal force is caused to act on the rotor core in a manufacturing step for the rotor shown in FIG. 15. FIG. 18 is a partial enlarged plan view for describing a state after centrifugal force has been caused to act on the rotor core in a manufacturing step for the rotor shown in FIG. 15. It is noted that hatching for facilitating understanding of the structures is provided only in FIG. 18. In other drawings, the structures are the same as those shown in FIG. 18, and hatching is omitted.

In the drawings, parts similar to those in the above embodiments are denoted by the same reference characters and description thereof is omitted. The first insertion hole 71 is divided by a first bridge portion 41, and thus, is composed of a first insertion hole 71A and a first insertion hole 71B. In the first insertion hole 71A and the first insertion hole 71B, a first magnet 61A and a first magnet 61B are disposed, respectively. Thus, the first magnet 61 is composed of the first magnet 61A and the first magnet 61B. The first bridge portion 41 is formed so that the first insertion hole 71A and the first insertion hole 71B are in left-right line symmetry with respect to the magnetic pole central axis in the first insertion hole 71. Accordingly, concentration of stress applied to the rotor core is reduced.

Similarly to the embodiments above, the hole-outside-peripheral-surface 80 and the hole-inside-peripheral-surface 81 are each formed in an arc surface shape that inwardly protrudes in the radial direction X of the rotor 3, the hole-outside-peripheral-surface 80 being the lateral surface extending in the circumferential direction Z and at the outside in the radial direction X of the first insertion hole 71A, 71B, the hole-inside-peripheral-surface 81 being the lateral surface extending in the circumferential direction Z and at the inside in the radial direction X of the first insertion hole 71A, 71B. In addition, similarly to the embodiments above, the magnet-outside-peripheral-surface 90 and the magnet-inside-peripheral-surface 91 are each formed in an arc surface shape that inwardly protrudes in the radial direction X of the rotor 3, the magnet-outside-peripheral-surface 90 being the surface extending in the circumferential direction Z and at the outside in the radial direction X of the first magnet 61A, 61B, the magnet-inside-peripheral-surface 91 being the surface extending in the circumferential direction Z and at the inside in the radial direction X of the first magnet 61A, 61B. The first gap portion 51 and the first adhesive layer portion 11 are formed in the same manner as in the embodiments above.

At the hole-inside-peripheral-surface 81 of the first insertion hole 71A, 71B, the first protruding portion 82 is formed which protrudes toward the outside in the radial direction X and which contacts with the circumferential-direction-side peripheral surface 92 that is on the opposite side to the side where the first bridge portion 41 in the circumferential direction Z of the first magnet 61A, 61B is formed. The first magnet 61 inserted in the first insertion hole 71 moves to the outside in the radial direction X, due to centrifugal force caused by rotation of the rotor core 30. Furthermore, the first magnet 61A, 61B does not contact with the first bridge portion 41. A gap is provided between the first bridge portion 41 and the another circumferential-direction-side peripheral surface 93 of the first magnet 61A, 61B, whereby the fourth gap portion 54 is formed.

The rotor for the rotary electric machine of embodiment 3 configured as described above can be manufactured as shown in FIG. 5 as in the embodiments above. However, before centrifugal force is caused to act by rotating the rotor core 30 and before the adhesive agent is hardened, the position of the magnet 6 could become unstable in the circumferential direction Z. Thus, by rotating the rotor core 30 to cause centrifugal force to act, it is possible to make the position of the magnet 6 stable in the insertion hole 7 as shown in FIG. 18. In the following, this state is described.

First, before centrifugal force acts, the magnet 6 and the insertion hole 7 are not completely fixed together by the adhesive agent as shown in FIG. 17. Thus, after the first magnet 61 is inserted in the first insertion hole 71, the first magnet 61 is pressed toward the outside in the radial direction X until the magnet-outside-peripheral-surface 90 contacts with the hole-outside-peripheral-surface 80, whereby the magnet-outside-peripheral-surface 90 and the hole-outside-peripheral-surface 80 contact with each other at two points. Further, the circumferential-direction-side peripheral surface 92 of the second magnet 62 is caused to contact with first protruding portion 82. However, before the adhesive agent is hardened, the first magnet 61 is not yet fixed in the circumferential direction Z of the rotor 3, and thus, the first magnet 61 could move to the magnetic pole central axis, that is, to the side where the first bridge portion 41 is formed. Thus, the position in the circumferential direction Z of the first magnet 61 is unstable. It is noted that the relationship between the second magnet 62 and the second insertion hole 72 is the same as that in embodiment 1 above, and description thereof is omitted.

In this state, the rotor core 30 is rotated to apply centrifugal force to the outside in the radial direction X of the rotor core 30, and the adhesive agent is hardened to form each adhesive layer portion 11, 12 (FIG. 18). That is, when the rotor 3 is rotated, centrifugal force toward the outside in the radial direction X of the rotor 3 is applied to the magnet 6 and the insertion hole 7. Due to this centrifugal force, the first magnet 61 moves to the outside in the radial direction X of the rotor 3, and the contacts at the two points between the magnet-outside-peripheral-surface 90 of the first magnet 61 and the hole-outside-peripheral-surface 80 of the first insertion hole 71 are fixed at the first location E and the second location F. In addition, the circumferential-direction-side peripheral surface 92 of the first magnet 61 contacts with the first protruding portion 82. As a result, the first magnet 61 contacts with the first insertion hole 71 at three locations therein, thereby being stabilized at a specific position.

According to embodiment 3 configured as described above, it is needless to say that the same effects as those in the embodiments above can be exhibited. Furthermore, even in a case where the first bridge portion is formed in the first insertion hole, when the rotor is rotated to apply centrifugal force to the first magnet, the magnet-outside-peripheral-surface of the first magnet and the hole-outside-peripheral-surface of the first insertion hole contact with each other at two locations, and the circumferential-direction-side peripheral surface of the first magnet contacts with the first protruding portion. Thus, the positional accuracy of the first magnet can be enhanced.

### Embodiment 4

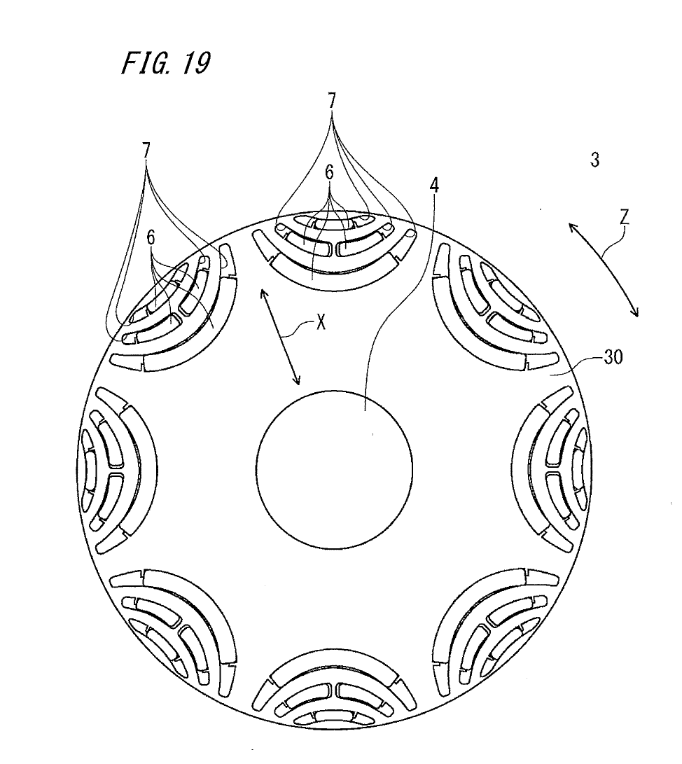

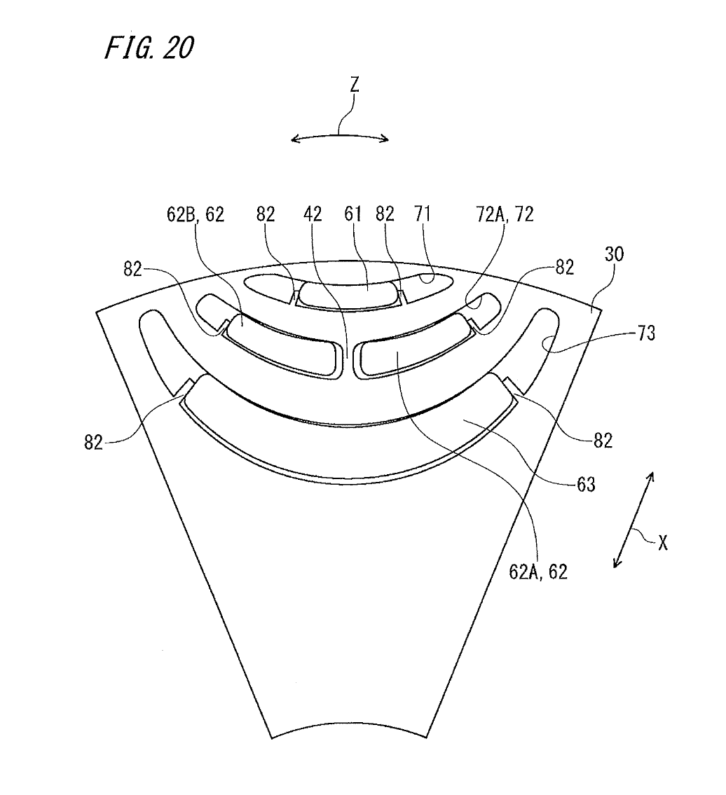

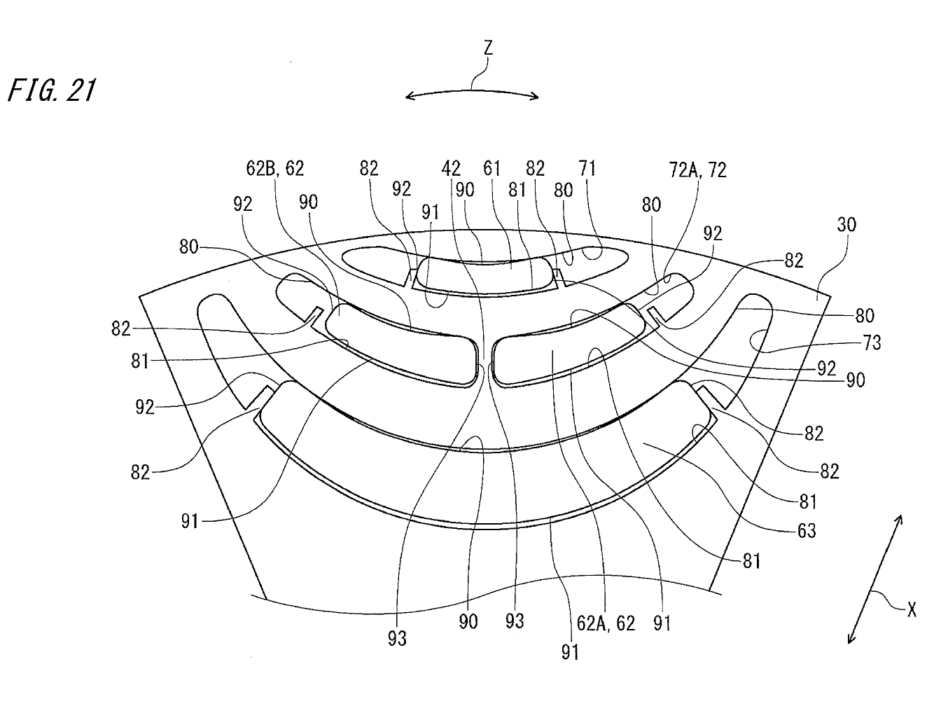

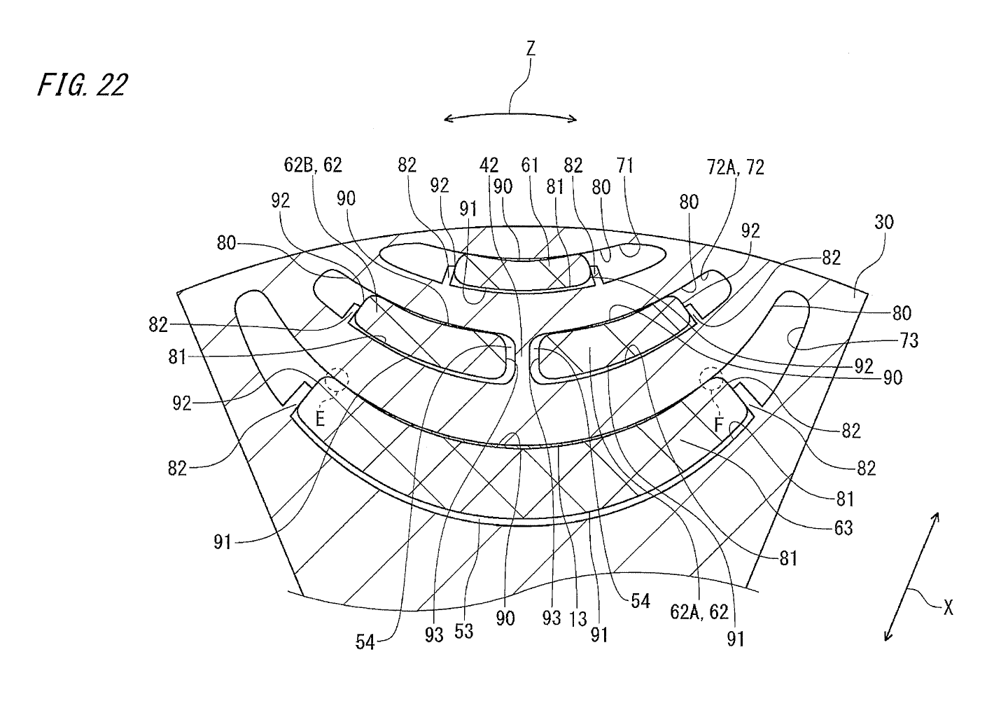

FIG. 19 is a plan view showing a configuration of a rotor of embodiment 4 of the present invention. FIG. 20 is a partial enlarged plan view showing a configuration of a ⅛ model of the rotor shown in FIG. 19. FIG. 21 is a partial enlarged plan view for describing a state before centrifugal force is caused to act on the rotor core in a manufacturing step for the rotor shown in FIG. 19. FIG. 22 is a partial enlarged plan view for describing a state where centrifugal force has been caused to act on the rotor core in a manufacturing step for the rotor shown in FIG. 19. It is noted that hatching for facilitating understanding of the structures is provided only in FIG. 22. In other drawings, the structures are the same as those shown in FIG. 22, and hatching is omitted.

In the drawings, parts similar to those in the above embodiments are denoted by the same reference characters and description thereof is omitted. In the present embodiment 4, an example is shown in which the insertion hole 7 is formed in three layers in the radial direction X of the rotor 3, whereby a third insertion hole 73 is provided. Thus, a third magnet 63 is inserted in the third insertion hole 73. In addition, the hole-outside-peripheral-surface 80 and the hole-inside-peripheral-surface 81 are each formed in an arc surface shape that inwardly protrudes in the radial direction X of the rotor 3, the hole-outside-peripheral-surface 80 being the lateral surface extending in the circumferential direction Z and at the outside in the radial direction X of the third insertion hole 73, the hole-inside-peripheral-surface 81 being the lateral surface extending in the circumferential direction Z and at the inside in the radial direction X of the third insertion hole 73. In addition, the magnet-outside-peripheral-surface 90 and the magnet-inside-peripheral-surface 91 are each formed in an arc surface shape that inwardly protrudes in the radial direction X of the rotor 3, the magnet-outside-peripheral-surface 90 being the surface extending in the circumferential direction Z and at the outside in the radial direction X of the third magnet 63, the magnet-inside-peripheral-surface 91 being the surface extending in the circumferential direction Z and at the inside in the radial direction X of the third magnet 63.

Furthermore, as shown in FIG. 22, the hole-outside-peripheral-surface 80 of the third insertion hole 73 and the magnet-outside-peripheral-surface 90 of the third magnet 63 contact with each other at two locations of the first location E and the second location F. The hole-inside-peripheral-surface 81 of the third insertion hole 73 and the magnet-inside-peripheral-surface 91 of the third magnet 63 do not contact with each other, with a gap provided therebetween, whereby a third gap portion 53 is formed.

A third adhesive layer portion 13 is formed between the first location E and the second location F and between the hole-outside-peripheral-surface 80 of the third insertion hole 73 and the magnet-outside-peripheral-surface 90 of the third magnet 63. The maximum interval L1 in the radial direction X of the third adhesive layer portion 13 is set in the same manner as in the embodiments above. At the hole-inside-peripheral-surface 81 of the third insertion hole 73, the first protruding portion 82 which protrudes toward the outside in the radial direction X and which contacts with the circumferential-direction-side peripheral surface 92 in the circumferential direction Z of the third magnet 63 is formed in the circumferential direction Z. It is unknown which of the directions in the circumferential direction Z the third magnet 63 inserted in the third insertion hole 73 moves in due to the centrifugal force caused by rotation of the rotor core 30. Therefore, the first protruding portion 82 is formed at two locations in the circumferential direction Z, so as to allow either of the circumferential-direction-side peripheral surfaces 92 in the circumferential direction Z of the third magnet 63 to contact with the first protruding portion 82 in the circumferential direction Z within the third insertion hole 73.

Similarly to the embodiments above, the rotor for the rotary electric machine of embodiment 4 configured as described above can be manufactured as shown in FIG. 5. However, before centrifugal force is caused to act by rotating the rotor core 30, and before the adhesive agent is hardened, the position of the magnet 6 could become unstable in the circumferential direction Z. Thus, by rotating the rotor core 30 to cause centrifugal force to act, it is possible to make the position of the magnet 6 stable in the insertion hole 7 as shown in FIG. 22. In the following, this state is described.

First, before centrifugal force acts, the magnet 6 and the insertion hole 7 are not completely fixed together by the adhesive agent as shown in FIG. 21. It is noted that the relationship between the first magnet 61 and the first insertion hole 71, and the relationship between the second magnet 62 and the second insertion hole 72 are the same as those in embodiment 1 above, and thus, the description thereof is omitted. After the third magnet 63 is inserted in the third insertion hole 73, the third magnet 63 is pressed toward the outside in the radial direction X until the magnet-outside-peripheral-surface 90 contacts with the hole-outside-peripheral-surface 80, whereby the magnet-outside-peripheral-surface 90 and the hole-outside-peripheral-surface 80 contact with each other at two points. Further, the circumferential-direction-side peripheral surface 92 of the second magnet 62 is caused to contact with the first protruding portion 82. However, before the adhesive agent is hardened, the third magnet 63 is not yet fixed in the circumferential direction Z of the rotor 3. Thus, variation in the insertion manner of the third magnet 63 causes the third magnet 63 to contact with either of the left and right first protruding portions 82, or to contact with neither of the left and right first protruding portions 82. Thus, the position in the circumferential direction Z of the third magnet 63 is unstable.

In this state, the rotor core 30 is rotated to apply centrifugal force to the outside in the radial direction X of the rotor core 30, and the adhesive agent is hardened to form each adhesive layer portion 11, 12, 13 (see FIG. 22). That is, when the rotor 3 is rotated, centrifugal force toward the outside in the radial direction X of the rotor 3 is applied to the magnet 6 and insertion hole 7. Due to this centrifugal force, the third magnet 63 moves to the outside in the radial direction X of the rotor 3, and the contacts at two points between the magnet-outside-peripheral-surface 90 of the third magnet 63 and the hole-outside-peripheral-surface 80 of the third insertion hole 73 are fixed at the first location E and the second location F. In addition, either of the left and right circumferential-direction-side peripheral surfaces 92 in the circumferential direction Z of the third magnet 63 contacts with a corresponding one of the left and right first protruding portions 82. As a result, the third magnet 63 contacts with the third insertion hole 73 at three locations therein, thereby being stabilized at a specific position.

According to embodiment 4 configured as described above, it is needless to say that the same effects as those in the embodiments above can be exhibited. Furthermore, by setting the number of layers of the insertion hole to three, the amount of magnetic flux flowing in the rotor can be increased, and thus, torque can be enhanced.

It is noted that, within the scope of the present invention, the above embodiments may be combined with each other, or each of the above embodiments may be modified or simplified as appropriate.

1. A rotor comprising:
a rotor core in which a plurality of insertion holes each penetrating the rotor core in an axial direction are formed with intervals interposed thereamong in a circumferential direction; and
magnets respectively provided in the insertion holes, wherein
a hole-inside-peripheral-surface of each insertion hole does not contact with a magnet-inside-peripheral-surface of a corresponding one of the magnets,
a hole-outside-peripheral-surface of the insertion hole and a magnet-outside-peripheral-surface of the magnet contact with each other at two locations of a first location and a second location,
an adhesive layer portion is formed between the first location and the second location and between the hole-outside-peripheral-surface of the insertion hole and the magnet-outside-peripheral-surface of the magnet, and
a first protruding portion which protrudes toward outside in a radial direction is formed at the hole-inside-peripheral-surface of the insertion hole, and the first protruding portion contacts with a circumferential-direction-side peripheral surface of the magnet.

2. The rotor according to claim 1, wherein
the rotor includes an insertion hole, among the insertion holes, that is divided by a bridge portion, and
the first protruding portion of the insertion hole divided by the bridge portion is formed so as to contact with an outer peripheral side of the circumferential-direction-side peripheral surface of the magnet.

3. The rotor according to claim 2, wherein
at the bridge portion of the insertion hole divided by the bridge portion, second protruding portions that respectively protrude to the magnet sides in the insertion hole and that do not contact with the magnet are formed.

4. The rotor according to claim 1, wherein
the hole-outside-peripheral-surface of the insertion hole and the magnet-outside-peripheral-surface of the magnet are each formed in an arc surface shape that inwardly protrudes in the radial direction.

5. The rotor according to claim 1, wherein
a maximum interval L1 in the radial direction of the adhesive layer portion is set to satisfy
b/100 (mm)<L1<20/100 (mm)

6. The rotor according to claim 1, wherein the insertion hole is formed in a plurality of layers in the radial direction.

7. A rotary electric machine comprising:
a rotor;
a rotation shaft for rotating a rotor core; and
a stator having a coil, and disposed with an air gap interposed between the stator and the rotor,
wherein the rotor comprises:
the rotor core in which a plurality of insertion holes each penetrating the rotor core in an axial direction are formed with intervals interposed thereamong in a circumferential direction; and
magnets respectively provided in the insertion holes, wherein
a hole-inside-peripheral-surface of each insertion hole does not contact with a magnet-inside-peripheral-surface of a corresponding one of the magnets,
a hole-outside-peripheral-surface of the insertion hole and a magnet-outside-peripheral-surface of the magnet contact with each other at two locations of a first location and a second location,
an adhesive layer portion is formed between the first location and the second location and between the hole-outside-peripheral-surface of the insertion hole and the magnet-outside-peripheral-surface of the magnet, and
a first protruding portion which protrudes toward outside in a radial direction is formed at the hole-inside-peripheral-surface of the insertion hole, and the first protruding portion contacts with a circumferential-direction-side peripheral surface of the magnet.

8. A method for manufacturing a rotor,
wherein the rotor comprises:
a rotor core in which a plurality of insertion holes each penetrating the rotor core in an axial direction are formed with intervals interposed thereamong in a circumferential direction; and
magnets respectively provided in the insertion holes, wherein
a hole-inside-peripheral-surface of each insertion hole does not contact with a magnet-inside-peripheral-surface of a corresponding one of the magnets,
a hole-outside-peripheral-surface of the insertion hole and a magnet-outside-peripheral-surface of the magnet contact with each other at two locations of a first location and a second location,
an adhesive layer portion is formed between the first location and the second location and between the hole-outside-peripheral-surface of the insertion hole and the magnet-outside-peripheral-surface of the magnet, and
a first protruding portion which protrudes toward outside in a radial direction is formed at the hole-inside-peripheral-surface of the insertion hole, and the first protruding portion contacts with a circumferential-direction-side peripheral surface of the magnet, wherein the method comprises:
a step of applying an adhesive agent to the magnet-outside-peripheral-surface of the magnet;
a step of inserting the magnet into the insertion hole;
a step of pressing the magnet-outside-peripheral-surface of the magnet and the hole-outside-peripheral-surface of the insertion hole against each other;
a step of pressing the circumferential-direction -side peripheral surface of the magnet against the first protruding portion; and
a step of forming the adhesive layer portion by causing the adhesive agent to be hardened with the rotor core being rotated.

9. A method for manufacturing a rotor,
wherein the rotor comprises:
a rotor core in which a plurality of insertion holes each penetrating the rotor core in an axial direction are formed with intervals interposed thereamong in a circumferential direction; and
magnets respectively provided in the insertion holes, wherein
a hole-inside-peripheral-surface of each insertion hole does not contact with a magnet-inside-peripheral-surface of a corresponding one of the magnets,
a hole-outside-peripheral-surface of the insertion hole and a magnet-outside-peripheral-surface of the magnet contact with each other at two locations of a first location and a second location,
an adhesive layer portion is formed between the first location and the second location and between the hole-outside-peripheral-surface of the insertion hole and the magnet-outside-peripheral-surface of the magnet, and
a first protruding portion which protrudes toward outside in a radial direction is formed at the hole-inside-peripheral-surface of the insertion hole, and the first protruding portion contacts with a circumferential-direction-side peripheral surface of the magnet, wherein the method comprises:
a step of applying an adhesive agent to the magnet-outside-peripheral-surface of the magnet,
a step of inserting the magnet into the insertion hole;
a step of pressing the magnet-outside-peripheral-surface of the magnet and the hole-outside-peripheral-surface of the insertion hole against each other; and
a step of forming the adhesive layer portion, by pressing the circumferential-direction-side peripheral surface of the magnet against the first protruding portion and causing the adhesive agent to be hardened, with the rotor core being rotated.

10. The rotor according to claim 2, wherein
the hole-outside-peripheral-surface of the insertion hole and the magnet-outside-peripheral-surface of the magnet are each formed in an arc surface shape that inwardly protrudes in the radial direction.

11. The rotor according to claim 3, wherein
the hole-outside-peripheral-surface of the insertion hole and the magnet-outside-peripheral-surface of the magnet are each formed in an arc surface shape that inwardly protrudes in the radial direction.

12. The rotor according to claim 2, wherein
a maximum interval L1 in the radial direction of the adhesive layer portion is set to satisfy
5/100 (mm)<L1<20/100 (mm).

13. The rotor according to claim 3, wherein
a maximum interval L1 in the radial direction of the adhesive layer portion is set to satisfy
5/100 (mm)<L1<20/100 (mm).

14. The rotor according to claim 4, wherein
a maximum interval L1 in the radial direction of the adhesive layer portion is set to satisfy
5/100 (mm)<L1<20/100 (mm).

15. The rotor according to claim 2, wherein
the insertion hole is formed in a plurality of layers in the radial direction.

16. The rotor according to claim 3, wherein
the insertion hole is formed in a plurality of layers in the radial direction.

17. The rotor according to claim 4, wherein
the insertion hole is formed in a plurality of layers in the radial direction.

18. The rotor according to claim 5, wherein
the insertion hole is formed in a plurality of layers in the radial direction.
